(19) United States
(12) Patent Application Publication
(10) Pub. No.: US 2015/0000633 A1
(43) Pub. Date: Jan. 1, 2015

(54) Vertical and Horizontal Engine

(71) Applicant: ETG Limited, Hong Kong (CN)

(72) Inventor: Katsumi KURIHARA, Aichi (JP)

(21) Appl. No.: 13/932,587

(22) Filed: Jul. 1, 2013

(51) Int. Cl. F01M 1/02; F02B 75/00; F02D 31/00

(52) U.S. Cl. CPC F01M 1/02; F02D 31/00; F02B 75/007
USPC 123/319; 123/90.31

(57) ABSTRACT

An engine lubrication and speed control method is provided. The four-cycle engine has a engine block having a cylindrical bore and an enclosed oil reservoir formed therein. A vertical or horizontal crankshaft is rotatably mounted in the engine block for rotation about a crankshaft axis. An oil pump, which is driven by the camshaft connected with a cam gear or driven by the crank shaft connecting with the crank gear, inhales the oil from the oil reservoir to splash lubricate into the cylinder bore and valve chamber. A speed control governor is provided on the wall of the cylinder block. The engine is provided with a cylinder head assembly defining a compact combustion chamber having a pair of overhead intake and exhaust ports and cooperating intake and exhaust valves. A commonality of parts between the horizontal and the vertical engine is highly achieved.

### FIELD

This invention relates to an engine, and more particularly, a small four-cycle utility engine that is particularly suitable for typical power tools driven by a vertical or horizontal power shaft.

### BACKGROUND

Portable power tools such as line trimmers, blowers/vacuums, and chain saws must be able to run in a very wide range of orientations. However, in most power tools such as generators or tillers/cultivators, power shaft orientation is either substantially horizontal or vertical. Therefore, it is not necessary for these typical power tools to be able to run in a very wide range of orientations having complicated and economically ineffective constructions.

For some tillers/cultivators powered by four-cycle engines with a vertical power shaft, lubrication also becomes a serious problem since it is difficult to use the same lubrication system as engines with a horizontal power shaft.

U.S. Pat. No. 6,250,273 to Ryuu et al. discloses a prior art utility engine for horizontal and vertical shaft orientations, which is incorporated herein by reference. However, constructions are still complicated because special rotating parts having inclined shafts to a crankshaft or a camshaft are necessary for lubrication and speed control.

Further, because the splashing blades 41 adjacent the driven gear 40 are immersed in an oil in the oil reservoir 17 and splash oil in the direction which is composed by the peripheral and centrifugal forces by rotation of rotary board 35, splashed oil is concentrated in the corner of crankcase and does not direct to the center portion of the crankcase to lubricate moving parts effectively and it produces heating of oil by useless churning.

Further, because the side cover has portions to support the intermediate shaft and the inclined governor shaft, size of the side cover is large and machining for the side cover is complicated and requires high level of accuracy.

Therefore, it is an object of the present invention to provide a small four-cycle utility engine having an internal lubrication system, which is especially suitable for both vertical and horizontal power shaft engines having components that are easy to make.

Although U.S. patent application Ser. No. 12/954,945 by Kurihara et al. and U.S. patent application Ser. No. 13/286,323 by Kurihara et al., which are incorporated herein by reference, disclose a useful prior art small four-cycle engine construction for portable power tools driven by a vertical or horizontal power shaft, to shorten the length of axial direction is required yet.

It is a further object of the present invention to provide a small four-cycle utility engine having a short axial length and speed control system enabling the engine to be run at a desired speed at any load, which is especially suitable for both vertical and horizontal power shaft engines.

It is yet a further object of the invention to provide a commonality of main parts between vertical and horizontal engines, which is especially suitable for both vertical and horizontal power shaft engines to reduce manufacturing cost.

These and other objects, features, and advantages of the present invention will become apparent upon further review of the remainder of the specification and the accompanying drawings.

### SUMMARY

In order to achieve the above objects, a four-cycle, utility engine is provided which is suitable for both vertical and horizontal power shaft engines.

The four-cycle, vertical shaft utility engine is provided with an engine block having at least one cylindrical bore oriented in a substantially horizontal orientation having an enclosed crankshaft chamber. A vertical crankshaft is pivotably mounted within the engine block. An enclosed oil reservoir is formed with the engine block and a crank shaft cover and is located below the crankshaft chamber. The enclosed oil reservoir when properly filled, enables the engine to rotate at least 30 degrees about the crankshaft axis in either direction without oil within the reservoir rising above the level of the crankshaft counter weight. A pump is connected drivably to a cam gear-cam assembly or to a speed governor assembly, said pump inhales lubrication oil from the oil reservoir through an inhale passage on a wall of the cylinder block to splash oil into the cylinder and valve train. Said inhale passage of the oil pump is extended to near the crank shaft cover, which is located below the cylindrical bore when the power shaft of said engine is oriented to be horizontal.

A sister engine, which is a horizontal shaft utility engine, is provided. Main parts of both vertical and horizontal engine are substantially common. The sister engine has an engine block having at least one cylindrical bore oriented in a substantially vertical orientation having an enclosed crankshaft chamber. A horizontal crankshaft is pivotably mounted within the engine block. An enclosed oil reservoir formed with the engine block and a crank shaft cover and is located below the crankshaft chamber. The enclosed oil reservoir when properly filled, enables the engine to rotate at least 30 degrees about the crankshaft axis in either direction without oil within the reservoir rising above the level of the crankshaft counter weight. A pump is connected drivably to a cam gear-cam assembly or to a speed governor assembly, and said pump inhales lubrication oil from the oil reservoir through an inhale passage on the cylinder block to splash oil into the cylinder and valve train.

In both the vertical and horizontal engine, a breathing system is provided at a location in which an oil level within the reservoir is not above the breathing system.

### BRIEF DESCRIPTION OF DRAWINGS

FIG. 1 is a cross-sectional side elevation view of the vertical shaft engine taken along the rotating axis of the crankshaft and axis of cylinder bore.

FIG. 2 is a cross-sectional side elevation view of the horizontal shaft engine taken along the rotating axis of the crankshaft and axis of cylinder bore.

FIG. 3 is a cross-sectional side elevation view of another embodiment of a vertical shaft engine taken along the rotating axis of the crankshaft and axis of cylinder bore.

FIG. 4 is a cross-sectional side elevation view of another embodiment of a horizontal shaft engine taken along the rotating axis of the crankshaft and axis of cylinder bore.

FIG. 5 is a cross-sectional side elevation view of the engine taken along line A-A in FIG. 2 to show detail construction of breather system and speed governor.

FIG. 6 is an enlarged schematic illustration of the camshaft and the follower mechanism.

### DESCRIPTION OF EMBODIMENTS

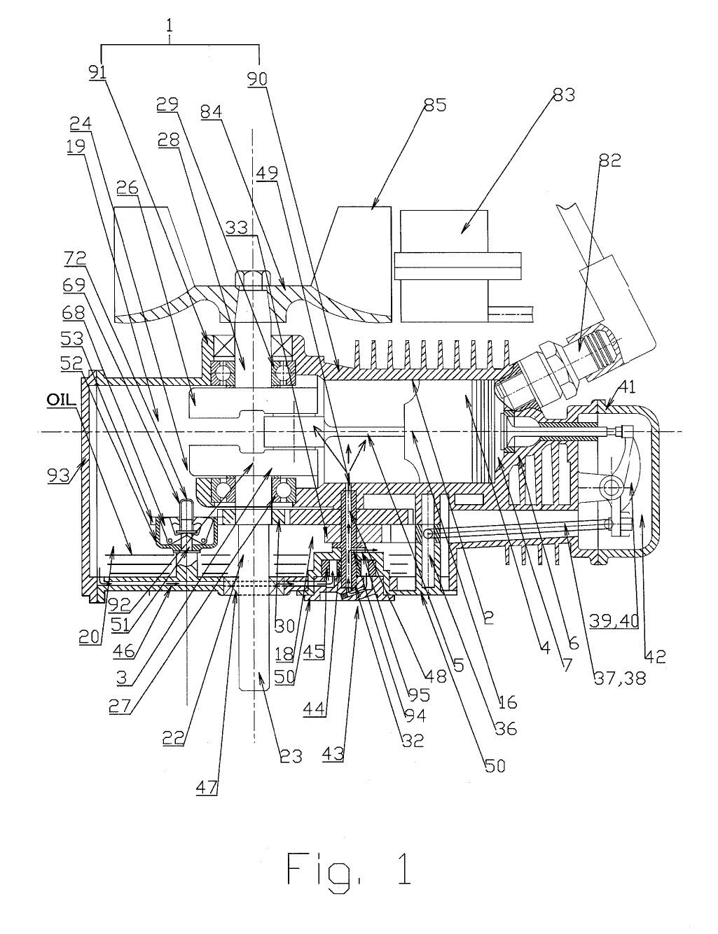

FIG. 1 illustrates a cross-sectional side elevation view of a vertical shaft four-cycle engine. The four-cycle engine is made up of a lightweight aluminum housing including a cylinder block 1 having a cylindrical bore 2 formed therein. The cylinder block 1 is defined by a cylinder 90 and a lower case 91 mating each other in a plane which is perpendicular to the cylinder axis 16 and includes crankshaft axis 92.

The cylinder block 1 forms a crankshaft chamber 19.

The lower case 91 and the crankshaft cover 93 provide an enclosed oil reservoir 20 in a vertical shaft engine as illustrated in FIG. 1.

A crankshaft 3 is a power shaft and is pivotably mounted within the engine block 1 in a conventional manner. A piston 4 slides within the cylinder bore 2 and is connected to the crankshaft 3 by a connecting rod 5. A cylinder head 6 is affixed to the engine block 1 to define an enclosed combustion chamber 7.

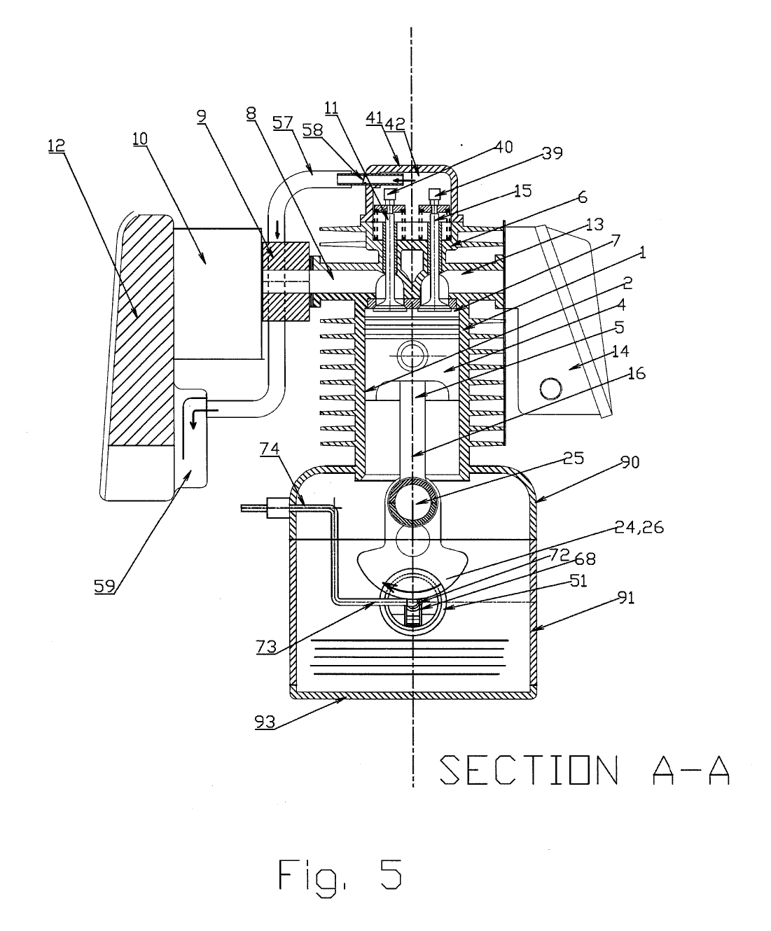

In FIG. 5, the cylinder head 6 is provided with an intake port 8 coupled to an insulator 9 and carburetor 10 and selectively connected to the combustion chamber 7 via an intake valve 11. A filter element 12 of an air cleaner is provided to eliminate dust from the intake air into the engine. The cylinder head 6 is also provided with an exhaust port 13 connected to a muffler 14 and selectively connected to the combustion chamber 7 by an exhaust valve 15.

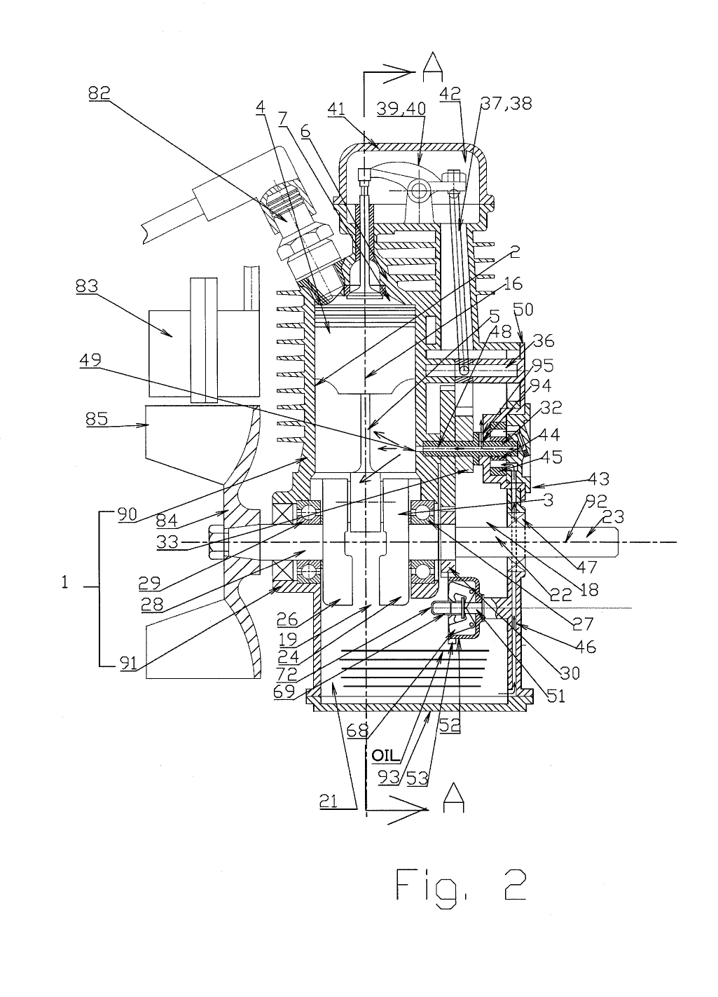

FIG. 2 illustrates a cross-sectional side elevation view of a horizontal shaft four-cycle sister engine. Main parts of both vertical and horizontal engine are substantially common. The four cycle engine has an engine block 1 having at least one cylindrical bore oriented in a substantially vertical orientation having an enclosed crankshaft chamber 19. The cylinder block 1 is defined by a cylinder 90 and a lower case 91 mating each other in a plane which is perpendicular to the cylinder axis 16 and includes crankshaft axis 92.

A horizontal crankshaft 3 is pivotably mounted within the engine block 1. An enclosed oil reservoir 21 is formed within the engine block 1 and a crank shaft cover 93 and is located below the crankshaft chamber 19. The enclosed oil reservoir 21 when properly filled, enables the engine to rotate at least 30 degrees about the crankshaft axis 92 in either direction without oil within the oil reservoir 21 rising above the level of the crankshaft counter weight.

As illustrated in FIGS. 1 and 2, the cylinder axis 16 of a four-cycle engine is generally upright when in a horizontal power shaft engine and is generally horizontal when in a vertical power shaft engine.

The oil reservoir 20 or 21 is relatively deep so that there is ample clearance between the crankshaft 3 and the level of the oil within the oil reservoir during normal use (vertical or horizontal orientation of the crankshaft).

The crankshaft 3 is provided with an axial shaft 22 coupled to an output end 23 adapted to be coupled to a counterweight web 24.

A crankpin 25 is affixed to counterweight web 24 and is parallel to and radially offset from the axial shaft 22. The crankpin 25 pivotally cooperates with connecting rod 5.

The axial shaft 22 of crankshaft 3 is pivotably attached to the cylinder block 1 by a bearing 27.

Another axial shaft 28 of the crankshaft 3 is coupled to a counterweight web 26 and is pivotably attached to the cylinder block 1 by a bearing 29.

At the side of bearing 27 is a crank gear 30.

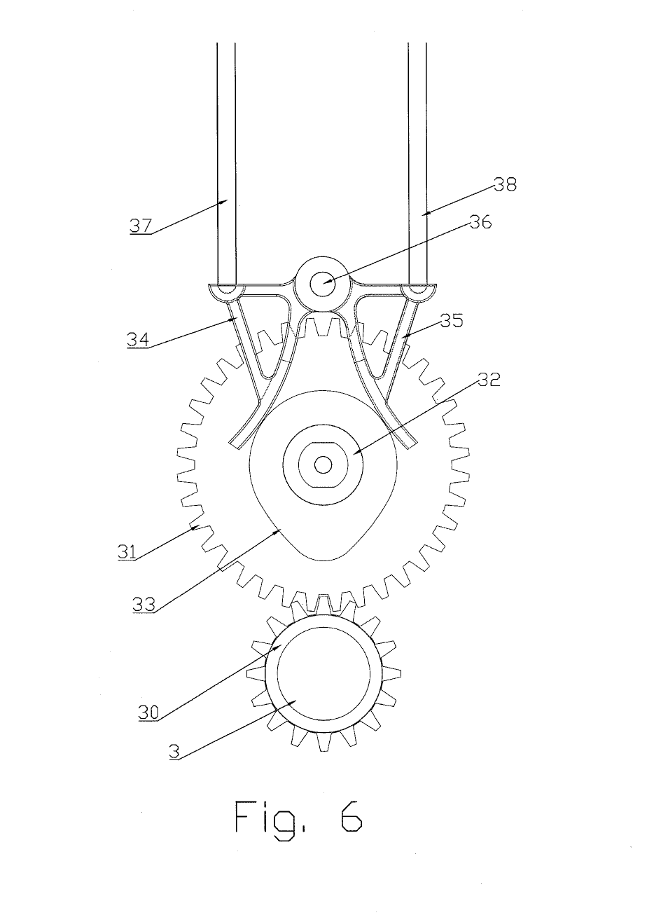

A camshaft drive and valve lifter mechanism is best illustrated in FIGS. 1 and 6.

The crank gear 30 is mounted on the crankshaft 3, which in turn drives a cam gear 31 with twice the number of teeth as the crank gear 30 resulting in the camshaft 32 rotating at one-half engine speed. The cam gear 31 is affixed to the camshaft 32 which includes a rotary cam lobe 33.

In the embodiment illustrated, a single cam lobe 33 is utilized for driving both the intake and exhaust valves 11, 15.

Followers 34 and 35 are pivotably connected to the cylinder block 1 by a pivot pin 36.

Push rods 37 and 38 extend between camshaft followers 34 and 35 and rocker arms 39 and 40 located within the cylinder head 6. The cam lobe 33, push rods 37, 38 and rocker arms 39, 40 are part of a valve train assembly. Affixed to the cylinder head 6 is a valve cover 41 which defines therebetween an enclosed valve chamber 42.

As illustrated in FIG. 1 and FIG. 2, a cam chamber cover 50 is attached to the wall of the cylinder 90. An end of the camshaft 32 is journaled to the wall of cylinder bore 2 of the cylinder 90. The other end of said cam shaft 32 is journaled to a cam chamber cover 50. An end of the pivot pin 36 is supported at the wall of cylinder bore 2 and the other end of said pivot pin is supported by the cam chamber cover 50. Cylinder 90 and cam chamber cover defines a cam chamber 18.

In order to lubricate the engine, a trochoid pump 43 is placed at the cam chamber cover 50.

The pump 43 has an inner rotor 44 and outer rotor 45. In other embodiments of the present application, a gear pump may be used.

The camshaft 32 drives the inner rotor 44 and the outer rotor 45 is rotated following the rotation of the inner rotor 44.

Lubrication oil is inhaled from a passage 46, which is extended to the crank shaft cover 93. An oil seal 47 is installed on the cylinder block 1 to prevent leakage of oil from the crank shaft chamber 19.

An end of the passage 46 leads to the oil entrance of the pump. The other end of passage 46 is connected to an oil entrance at oil reservoir 20 or 21.

In the vertical shaft engine as illustrated in FIG. 1, the entrance of the oil passage 46 is dipped in the oil in the oil reservoir 20 within a certain inclination range of the power shaft from the normal position, because the oil passage 46 is substantially horizontal at the normal position.

In the horizontal shaft engine as illustrated in FIG. 2, although oil passage 46 is substantially vertical at the normal position, the entrance of the oil passage 46 is dipped in the oil in the oil reservoir 21 within a certain inclination range of the power shaft from the normal position.

The pump 43 and the cylinder 90 can be commonly used between the vertical shaft engine as in FIG. 1 and the horizontal shaft engine as in FIG. 2.

The oil pushed out by the pump 43 is lead simultaneously to a hole 49 at the cylinder wall and to a hole 94 formed in the outer wall of the cam shaft 32 and a hole 95 in the cylinder 90 through an inner through hole 48 of the camshaft 32 and into the cylinder bore 2 as illustrated in FIG. 1 and FIG. 2.

Any other hole (not shown) at the wall of the camshaft 32 may lead oil to the valve actuating train. Accordingly, the engine parts inside the cylinder and crankcase are mist lubricated by the oil splashed by means of the rotation of and/or the centrifugal force generated by the rotating parts such as the web 24, 26 and the cam gear 31.

In the engine of FIGS. 1 and 2, a breather system is provided. The breather system is composed of a breather tube 57 and a check valve 58 as illustrated in FIG. 5.

As shown in FIG. 5, in the valve chamber 42, a breather tube 57 is opened through the valve cover 41 and is connected to an air cleaner case 59. The breathing oil mist sent through a tube is inhaled to the carburetor through a filter element 12. The check valve 58 is located at the position where it does not dip into oil in case of vertical or horizontal shaft engine.

As illustrated in FIGS. 2 and 5, a governor shaft 51 parallel to the crank shaft axis 92, is provided on the lower case 91 to compose a speed control system. A governor holder 52 is installed on the outer surface of said governor shaft 51 to be able to rotate. On the outer surface of said governor holder a governor gear 53 is provided to mate with the crank gear 30. By the rotation of the crank shaft 3, said governor gear 53 is rotated.

On the governor holder 52, a set of fly weights 68 for speed control of the engine is provided. The fly weights 68 are pivotably inserted by pin to the governor holder 52.

As shown in FIG. 2, the end of the fly weight 68 attaches to a slide piece 69. The slide piece 69 is supported to slide on the governor shaft 51.

When engine runs, the fly weight 68 is spread outwardly by centrifugal force and pushes the slide piece 69 to slide. On the other end of the slide piece 69, a contact face 72 is provided to contact the lever 73, which is affixed by a rotatable shaft 74.

The shaft 74 is pivotably provided on the wall of cylinder 1. Rotation of said shaft 74 controls engine speed with said carburetor 10.

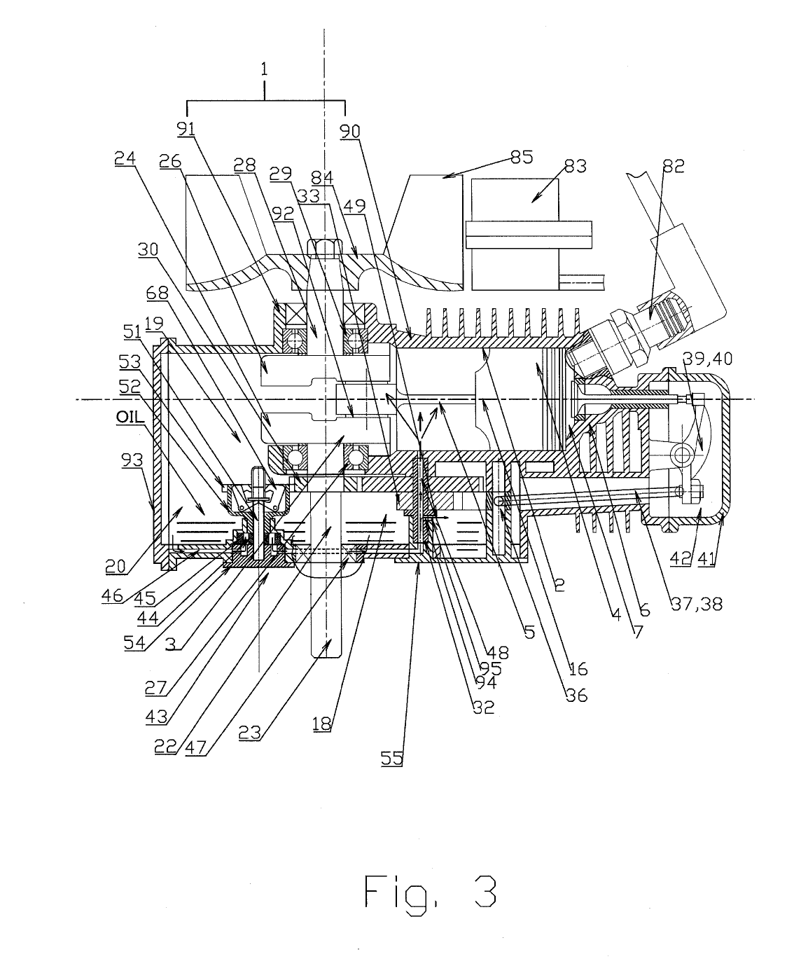

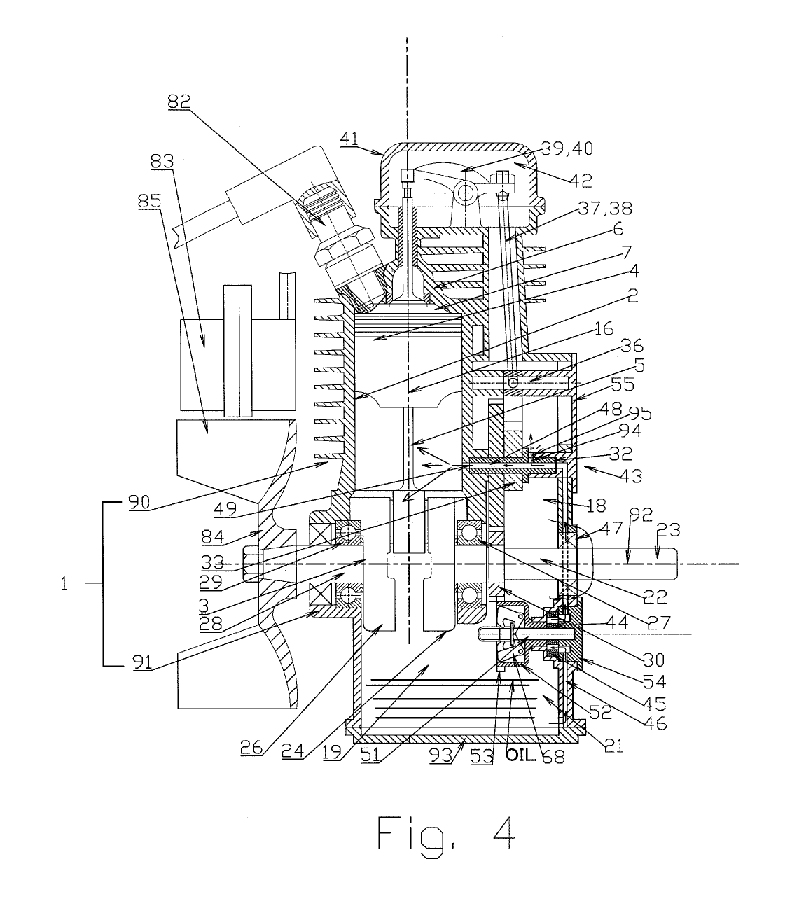

FIGS. 3 and 4 show another embodiment of the present invention. FIG. 3 corresponds to FIG. 1 and FIG. 3 corresponds to FIG. 4. The difference between FIG. 1 and FIG. 3 and between FIG. 2 and FIG. 4 is location and construction of pumps and speed governors.

A cam chamber cover 55 is attached to the wall of the cylinder 90. An end of the camshaft 32 is journaled to the wall of cylinder bore 2 of the cylinder 90. The other end of said cam shaft 32 is journaled to a cam chamber cover 55. An end of the pivot pin 36 is supported at the wall of cylinder bore 2 and the other end of said pivot pin is supported by the cam chamber cover 55. Cylinder 90 and cam chamber cover define a cam chamber 18.

In FIGS. 3 and 4, a trochoid pump 43 is placed at the wall of lower case 91. Said pump 43 has an inner rotor 44 and outer rotor 45. A pump cover 54 is placed at the wall of the lower case 91 and covers the inner rotor 44 and the outer rotor 45. As illustrated in FIGS. 3,4 and 5, a governor shaft 51 parallel to the crank shaft axis 92, is provided on said pump cover 54 to compose a speed control governor.

A governor holder 52 is installed on said governor shaft 51 to be able to rotate. On the outer surface of said governor holder a governor gear 53 is provided to mate with the crank gear 30. By the rotation of the crank shaft 3, said governor gear 53 is rotated.

On the governor holder 52, a set of fly weights 68 for speed control of the engine is provided. The fly weights 68 are pivotably inserted by pin to the governor holder 52. The governor holder 52 is connected to the inner rotor 44 of said pump and drives the inner rotor 44 and the outer rotor 45 is rotated following the rotation of the inner rotor 44.

Lubrication oil is inhaled from a passage 46, which is extended to the crank shaft cover 93.

An end of the passage 46 leads to the oil entrance of the pump. The other end of passage 46 is connected to an oil entrance at oil reservoir 20 or 21.

In the vertical shaft engine as illustrated in FIG. 3, the entrance of the oil passage 46 is dipped in the oil in the oil reservoir 20 within a certain inclination range of the power shaft from the normal position, because the oil passage 46 is substantially horizontal at the normal position.

In the horizontal shaft engine as illustrated in FIG. 4, although oil passage 46 is substantially vertical at the normal position, the entrance of the oil passage 46 is dipped in the oil in the oil reservoir 21 within a certain inclination range of the power shaft from the normal position.

The pump 43 and the cylinder 90 can be commonly used between the vertical shaft engine as in FIG. 3 and the horizontal shaft engine as in FIG. 4.

The oil pushed out by the pump 43 is lead simultaneously to a hole 49 at the cylinder wall and to a hole 94 formed in the outer wall of the cam shaft 32 and a hole 95 in the cylinder 90 through an inner through hole 48 of the camshaft 32 and into the cylinder bore 2 as illustrated in FIG. 3 and FIG. 4.

In the embodiments of the present application illustrated in FIG. 3 or 4, a gear pump or a vortex pump may be used.

It is believed that small light-weight four cycle engines made in accordance with the present invention will be particularly suitable for use with utility power tools having a horizontal or vertical power shaft and is sufficiently manufactured to use common parts between vertical and horizontal shaft engines. In the prior art, U.S. Pat. No. 6,250,273 to Ryuu et al. discloses a prior art utility engine for horizontal and vertical shaft orientations. However, constructions are complicated because a speed controlling system having inclined shaft to a crankshaft or a camshaft are necessary for lubrication and speed control. Further, the side cover which supports a cam shaft and a governor shaft is large sized and the mating plane to the cylinder block is inclined, so that machining procedure is complicated and manufacturing cost is expensive.

On the other hand, present inventions as illustrated in FIGS. 1, 2, 3 and 4, any inclined speed governor shaft is not necessary.

Further, in the embodiment illustrated in FIGS. 1 and 2, because the governor shaft is provided in the lower case, none of additional parts such as the side cover in the prior art, U.S. Pat. No. 6,250,273 to Ryuu et al., is necessary to support the governor shaft.

Further, in the embodiment illustrated in FIGS. 3 and 4, the part to support the governor system is significantly smaller sized than the previous art, U.S. Pa. No. 6,250,273 to Ryuu et al.

Further, in the embodiment illustrated in FIGS. 3 and 4, because the inhale passage of oil from oil reservoir to the pump in vertical shaft usage is short, no priming instrument for the pump as in used in the prior art such as U.S. patent application Ser. No. 12/954,945 by Kurihara et al. or U.S. patent application Ser. No. 13/286,323 by Kurihara et al., is necessary.

Further, in the present invention, as illustrated in FIGS. 1, 2, 3 and 4, the governor holder 52 is not dipped in the lubrication oil, so that it does not agitate or heat the oil during normal operation. Lubrication is effectively done concentrating to adequate portion using a pump and the through hole in the cam shaft.

While the present invention is discussed in relation to the engine to be used with a small utility engine for stationary power tools, a person having ordinary skill in the art will readily realize that it can be also used with hand-held power tools or larger power equipment.

Other parts not specifically referenced to in the foregoing relate to conventional four-cycle engines. A spark plug 82 is installed in a spark plug hole formed in the cylinder head. A coil 83 is an ignition coil. A re-coil starter, not shown, having a re-winding rope is provided at a side of a flywheel 84, which inhales cooling air for the engine generated by rotation of blade 85 on the flywheel 84.

In vertical shaft engines as shown in FIG. 1 or FIG. 3, since oil entrance passage 46 is always dipped in the oil in the oil reservoir 20, lubricating oil is immediately inhaled to the oil pump 43 by rotation of the rotors 44, 45 through oil passage 46. The lubricating oil pressurized by the trochoid pump is sent into the cylinder or the valve train and lubricates moving parts of the engine.

In horizontal shaft engines such as those of FIG. 2 or FIG. 4, because oil entrance of the passage 46 is always dipped in the oil in the oil reservoir 21, lubricating oil pressurized by the trochoid pump is sent into the cylinder or the valve train and lubricates moving parts of the engine.

The breathing system works by the check valve 58 and pressure in the crankcase chamber 19 is kept normal during operation.

What is claimed is:

1. A single-cylinder, four-stroke cycle, spark ignition internal combustion engine for mounting on a power tool comprising:
a cylinder;
a lower case mating with the cylinder at a plane perpendicular to the cylinder axis;
a cylinder block defined by the cylinder and the lower case;
a cam chamber cover attached to the cylinder at a face parallel to an axis of said cylinder and perpendicular to a crankshaft axis defining a cam chamber with said cylinder;
a crankcase cover attached to the cylinder block defining a crankshaft chamber and an oil reservoir with said cylinder block;
a piston mounted for reciprocation in the cylinder;
a cylinder head attached with the cylinder defining an air-fuel combustion chamber;
an air-fuel mixture intake port and an exhaust gas port in said cylinder head;
a valve cover on said cylinder head defining a valve chamber;
an intake valve and an exhaust valve mounted in said intake and exhaust port, respectively, for reciprocation between port-open and port-closed positions;
a valve-actuating valve train, said valve train including at least one rocker arm and at least one valve train push rod assembly extending therefrom within said valve chamber and engaging said rocker arm;
a vertical crankshaft or a horizontal crankshaft pivotably mounted by ball bearing or plain bearing in the cylinder block, said crankshaft including a crank portion and at least one counterweight web, the axis of said crankshaft is included in the mating plane of the cylinder and the lower case;
a connecting rod having articulated connections at one end thereof to said piston and at an opposite end thereof to said crank portion, thereby forming a piston-connecting rod crankshaft assembly;
at least one cam rotatably mounted on a camshaft which is pivotably supported by said cylinder and said cam chamber cover, said camshaft is connected to a cam gear driven by a crank gear on said crankshaft at one-half crankshaft speed, the opposite end of said push rod assembly being drivably connected to said cam whereby said push rod assembly is actuated with a reciprocating motion upon rotation of said at least one cam; and
a trochoid oil pump connected drivably to said camshaft and placed at a cam chamber cover, wherein an inner and outer rotor of said pump are placed in said cam chamber cover and inhales lubrication oil from said oil reservoir through an inlet passage and splashes the oil simultaneously into the cylinder and into the valve actuating train to lubricate the engine parts inside the cylinder and the valve actuating train and the valve chamber, wherein an inlet hole of oil into said inlet passage is dipped in lubrication oil both in case of horizontal engine and vertical shaft engine.

2. The engine set forth in claim 1, further comprising;
a governor shaft placed at the lower case to be parallel to the crank shaft axis; and
a governor holder placed on said governor shaft to rotate and drivably connected to the crank shaft.

3. The engine set forth in claim 1, wherein the cylinder block, the cam chamber cover and main moving parts are substantially in common with each other between a vertical shaft engine and a horizontal shaft engine.

4. The engine set forth in claim 2, wherein the cylinder block, the cam chamber cover, the speed control governor and main moving parts are substantially in common with each other between a vertical shaft engine and a horizontal shaft engine.

5. A single-cylinder, four-stroke cycle, spark ignition internal combustion engine for mounting on a power tool comprising:
a cylinder;
a lower case mating with the cylinder at a plane perpendicular to the cylinder axis;
a cylinder block defined by the cylinder and the lower case;
a cam chamber cover attached to the cylinder at a face parallel to an axis of said cylinder and perpendicular to a crankshaft axis defining a cam chamber with said cylinder;
a crankcase cover attached to the cylinder block defining a crankshaft chamber and an oil reservoir with said cylinder block;
a piston mounted for reciprocation in the cylinder;
a cylinder head attached with the cylinder defining an air-fuel combustion chamber;
an air-fuel mixture intake port and an exhaust gas port in said cylinder head;
a valve cover on said cylinder head defining a valve chamber;
an intake valve and an exhaust valve mounted in said intake and exhaust port, respectively, for reciprocation between port-open and port-closed positions;
a valve-actuating valve train, said valve train including at least one rocker arm and at least one valve train push rod assembly extending therefrom within said valve chamber and engaging said rocker arm;
a vertical crankshaft or a horizontal crankshaft pivotably mounted by ball bearing or plain bearing in the cylinder block, said crankshaft including a crank portion and at least one counterweight web, the axis of said crankshaft is included in the mating plane of the cylinder and the lower case;
a connecting rod having articulated connections at one end thereof to said piston and at an opposite end thereof to said crank portion, thereby forming a piston-connecting rod crankshaft assembly;
at least one cam rotatably mounted on a camshaft which is pivotably supported by said cylinder and said cam chamber cover, said camshaft is connected to a cam gear driven by a crank gear on said crankshaft at one-half crankshaft speed, the opposite end of said push rod assembly being drivably connected to said cam whereby said push rod assembly is actuated with a reciprocating motion upon rotation of said at least one cam;
a trochoid oil pump placed at the wall of said lower case, wherein an inner and outer rotor of said pump are placed in said lower case and covered by a pump cover and inhales lubrication oil from said oil reservoir through an inlet passage and splashes the oil simultaneously into the cylinder and into the valve actuating train to lubricate the engine parts inside the cylinder and the valve actuating train and the valve chamber, wherein an inlet hole of oil into said inlet passage is dipped in lubrication oil both in case of horizontal engine and vertical shaft engine; and
a governor shaft placed at the pump cover to be parallel to the crank shaft axis;
a governor holder placed on said governor shaft to rotate and drivably connected to the crank shaft and connected to drive the inner rotor of the pump.

6. The engine set forth in claim 5, wherein the cylinder block, the cam chamber cover, the speed control governor and main moving parts are substantially in common with each other between a vertical shaft engine and a horizontal shaft engine.

7. The engine set forth in claim 5, wherein the pump is a vortex pump.

8. The engine set forth in claim 5, wherein the pump is a gear pump.
